(19) United States
(12) Patent Application Publication
(10) Pub. No.: US 2013/0182179 A1
(43) Pub. Date: Jul. 18, 2013

(54) CCD camera architecture and methods of manufacture

(71) Applicants: Stephen K. Page, Richardson, TX (US); Phillip R. Coffman, Richardson, TX (US)

(72) Inventors: Stephen K. Page, Richardson, TX (US); Phillip R. Coffman, Richardson, TX (US)

(21) Appl. No.: 13/373,855

(22) Filed: Jan. 17, 2012

(51) Int. Cl. H04N 5/225

(52) U.S. Cl. 348/373; 348/E05.024

(57) ABSTRACT

A charge-coupled device camera architecture for improving the dynamic range of the charge-coupled device camera having a charge-coupled device camera contained within a vacuum capable camera case and electrically attached to the outside of the camera case; a thermoelectric cooler thermally attached to a back side of the charge-coupled device camera and electrically attached to the outside of the camera case; a thermal redistribution block thermally attached to the thermoelectric cooler and further thermally attached to the camera case; a pressure measuring mechanism attached to an inside surface of the camera case and electrically connected to the outside of the camera case; a temperature measuring mechanism attached to a surface of the thermal redistribution block and electrically connected to the outside of the camera case; and a vacuum evacuation assembly having an indium lined copper pinch tube.

### FIELD OF THE INVENTION

Charge-Coupled Device (CCD) cameras have many uses in scientific, industrial and consumer electronics markets. They have been used for portable and studio cameras, x-ray detectors, microscope cameras, and the like. While CCD cameras work well under many lighting scenarios, in the area of microscopy and astronomy a growing number of applications require the CCD camera to deliver a clean signal with a wide dynamic range in situations where the illumination is minimal.

### BACKGROUND

In the area of scientific research and analysis, investigations through the microscope often involve the application of one or more dyes, or fluorochromes, to a sample cell (or other artifact) that are otherwise too small or lacking in sufficient natural contrast to be observed through the microscope. When exposed to narrow bands of energy, typically small segments of near UV to red visible light, the flourochromes release energy in the form of weak emissions in the visible light range.

In materials research, the use of near-infrared light (near IR) to investigate structures and features within a solid substance is common. The human eye cannot see specimens illuminated with light beyond the visible range (typically 400 nm to 700 nm). CCD sensors respond to near-infrared light energy into the 1500 nm range. However, the sensitivity of CCD cameras decline dramatically in the near-IR regions, though they are the most cost-effective solution. Near-infrared observations allow the observation of sub-surface defects in compound semiconductor crystals, substrates and thin films. It also enables the ability to image defects in bonded silicon wafers for silicon on insulator (SOI) and in three dimensional (3D) packaging applications, just to name a few.

In astronomy, heavenly bodies are easily observed if they are large and/or in close proximity to earth. Smaller bodies or bodies much farther from earth are not as easily discerned and the reduction of light energy reaching the observer is often weak and, therefore, imperceivable to the standard imaging system.

In these situations, and many others, CCD cameras cannot faithfully reproduce images of low light intensity because of dark current, which degrade the image. Dark current is the relatively small electric current that flows through charge-coupled devices, even when no photons are entering the device. It is present in all types of diodes to varying extents. Dark current is due to the random generation of electrons and holes within the depletion region of the device that are then swept away by the high electric field. The charge generation rate is related to specific crystallographic defects within the depletion region. This current adds electronic “noise” to the CCD output, typically obscuring the signal generated from what small amount of light that might reach the sensor. Physically cooling the CCD sensor, often times with thermoelectric cooler modules, which are also known as Peltier-effect coolers, within the camera reduces the dark current dramatically, resulting in a lower signal-to-noise ratio of the CCD output that enables more faithful reproduction of the image presented to it.

Cooling the CCD chip in the camera, as a consequence of lowering the dark current, increases the dynamic range. Dynamic range is the ratio between the largest and smallest possible values of either sound or light intensity. It is measured as a ratio, or as a base-10 (decibel) or base-2 (doublings, bits or stops) logarithmic value. The concepts of Signal-to-Noise Ratio (SNR) and dynamic range are closely related. Dynamic range measures the ratio between the strongest un-distorted signal on a channel and the minimum discernable signal, which for most purposes is the noise level. SNR measures the ratio between an arbitrary signal level (not, necessarily the most powerful signal possible) and noise. Measuring signal-to-noise ratios requires the selection of a representative or reference signal. SNR is usually taken to indicate an average signal-to-noise ratio, as it is possible that (near) instantaneous signal-to-noise ratios will be considerably different. The concept can be understood as normalizing the noise level to 1 (0 dB) and measuring how far the signal ‘stands out’.

In prior art, often times a vacuum is employed as an insulating medium, just as in cryogenic dewars and consumer thermos bottles. A vacuum effectively decreases convective heat loss.

The present invention solves several existing problems in manufacture or high materials costs, and concomitantly increases both reliability and performance.

### SUMMARY OF THE INVENTION

It is an object of the present invention to provide an improved CCD camera and mounting that increases the dynamic range of the CCD camera (and SNR).

It is another object of the present invention to provide a method for increasing the dynamic range of a CCD camera.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiment is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of a camera of the present invention.

FIG. 2 is a reverse perspective of view of the camera of the present invention.

FIG. 3 is a perspective view of the interior components of the camera of the present invention.

FIG. 4 is a reverse perspective view of the interior components of the camera of the present invention.

FIG. 5a is an exploded perspective view of the pinch pipe assembly of the camera of the present invention.

FIG. 5b is a cross sectional view of the pinch pipe assembly in an assembled state.

FIG. 5c is a side view of the pinch pipe assembly in an assembled state.

FIG. 6 is an exploded reverse perspective view of the interior components of the camera of the present invention.

FIG. 7 is a perspective view of the thermal redistribution block of the present invention.

FIG. 8 is a reverse perspective view of the thermal redistribution block of the present invention.

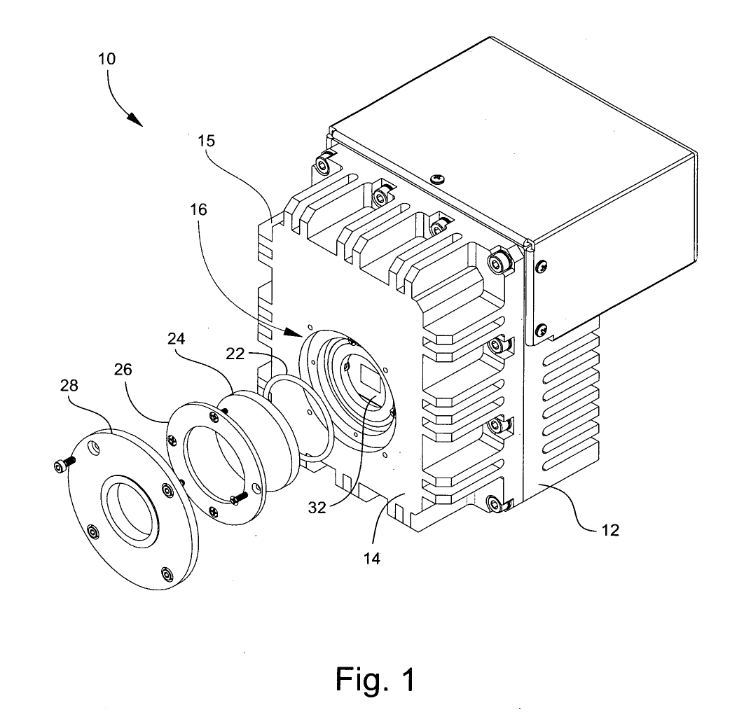

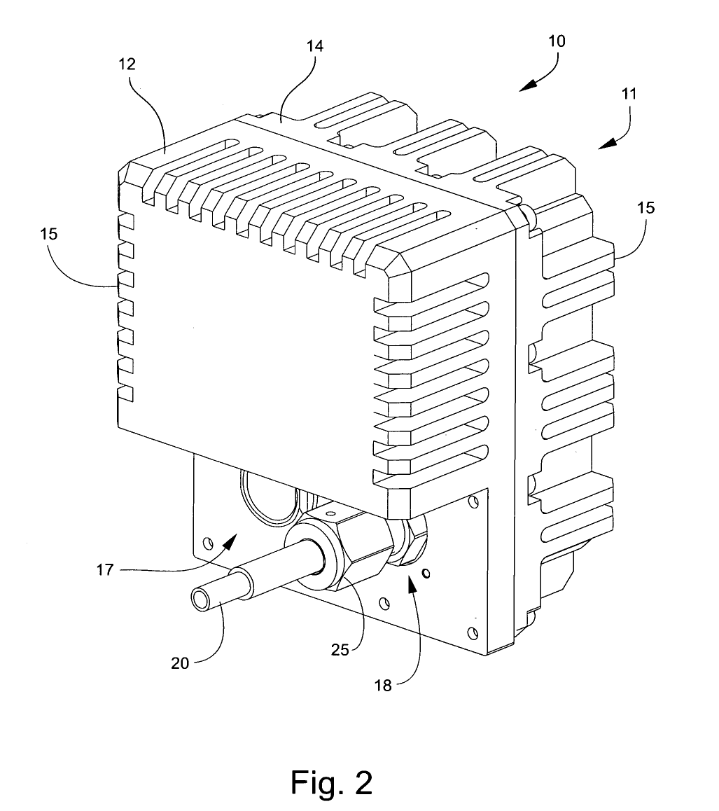

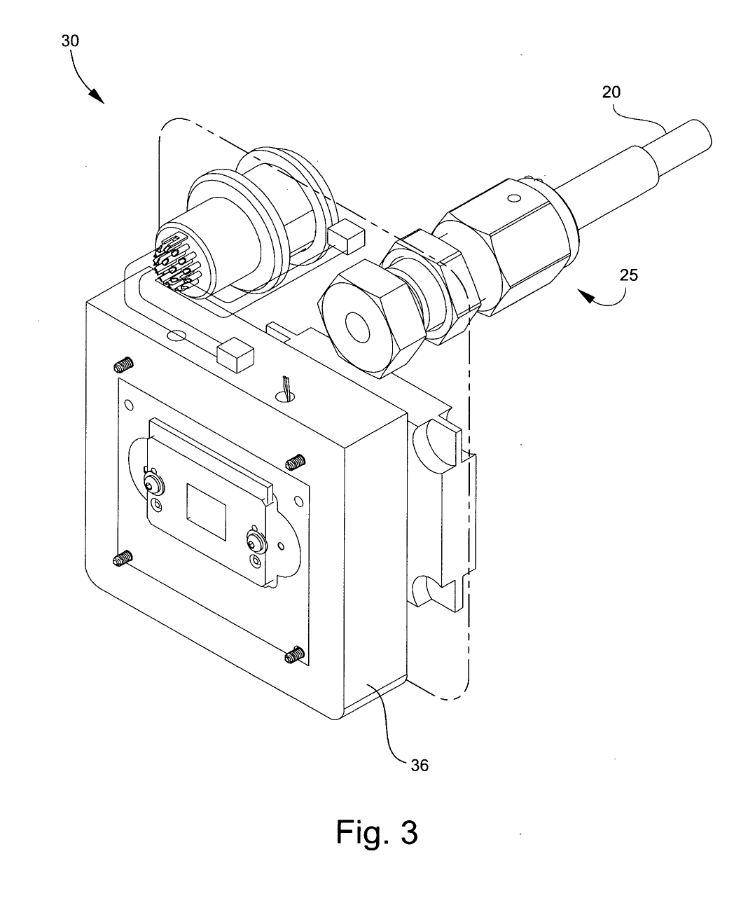

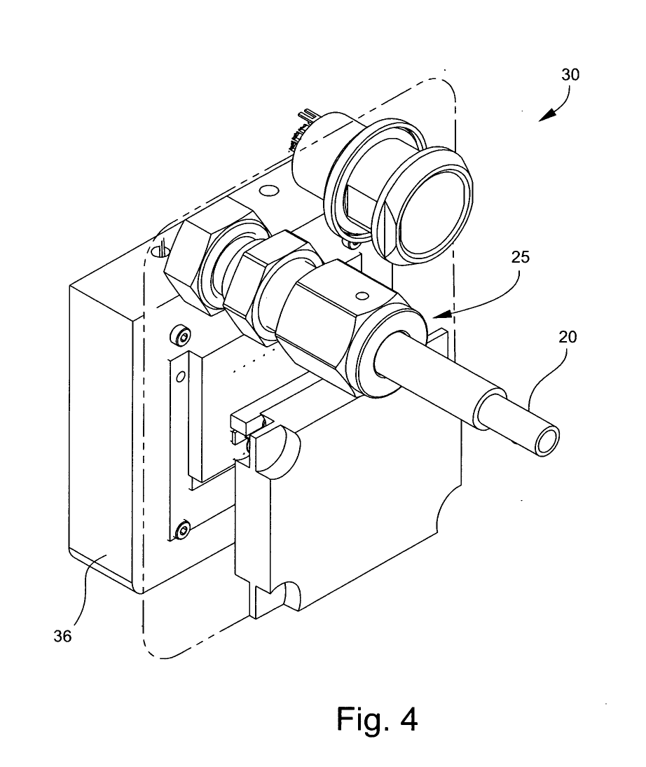

### DESCRIPTION OF PREFERRED EMBODIMENT

With reference to the drawings and in operation, the present invention provides an improved camera assembly 10 and method for increasing the dynamic range of CCD cameras used in low light applications.

Typically, CCD cameras used in low light situations have a threaded orifice called a “C” mount located at the front of the camera case 11. There will be an electronics I/O port(s) is at the opposite end. If the camera case 11 needs to be evacuated, a vacuum port will be included, typically located on the front or back of the camera case 11. Typical electrical connections are either an IEEE1394 or a USB-2 port. Further, there may exist an auxiliary power jack for low voltage DC supply and/or an auxiliary jack for remote trigger.

The camera assembly 10 according to the present invention comprises a camera case 11 comprising an upper enclosure 12 and a lower enclosure 14 that defines an interior space sized to encompass a CCD camera 50. The upper and lower enclosures, 12 and 14, are preferably sealable such that a vacuum may be maintained within the interior of the camera case 11. The camera case 11 of the present invention includes a “C” mount orifice 16, an electronics port 17 and vacuum port 18.

The “C” mount orifice 16 is located in the lower enclosure 14 and is capable of allowing light into the interior of the camera case 11. In a preferred embodiment, the “C” mount orifice 16 is sealed using first an O-ring 22 that fits around the “C” mount orifice 16, a quartz window 24 that fits over the O-ring 22, a compression ring 26 that fits over the quartz window 24. The compression ring 26 is secured to the lower enclosure using at least two screws, preferably four screws, thereby forcing the Quartz window 24 to compress the O-ring 22. When done correctly, this creates an airtight seal capable to maintaining a vacuum in the interior of the camera case 11. In a most preferred embodiment there is also a C-mount adapter 28 mounted over the compression ring 26 and to the lower enclosure 14. The C-mount adapter 28 is used to mount the camera case 11 onto a trinocular adapter on a microscope or to mount the camera case 11 to any standard lens assembly. The upper enclosure 12 includes the electronics port 17 and the vacuum port 18.

Both, the upper enclosure 12 and the lower enclosure 14, further integrally includes thermal dissipation (cooling) fins 15. These are use to dissipate any thermal energy received from the interior of the camera case 11 to the exterior of the camera case 11.

The camera assembly 30 according to the present invention includes an internal assembly comprising a CCD camera 32, a thermoelectric cooler 34 attached to the back side of the CCD camera 32 and a thermal redistribution block 36 attached to the thermoelectric cooler 34. The thermoelectric coolers 34 are mounted on the thermal redistribution blocks 36 and then the CCD chip (camera) 32 is thermally attached to the thermoelectric coolers 34.

The thermoelectric cooler 34 works by thermoelectrically cooling one side of the thermoelectric cooler 3 by electrically drawing heat to the opposite side. If the thermoelectric cooler 34 does not have a suitable attachment to a thermal redistribution block 36, then the hot side will increase in temperature and may become so hot that it melts any solder that attaches conductors for the electrical power. Also, since the thermoelectric cooler 34 does not achieve 100% efficiency, more heat is always generated than the amount of cold produced. If the heat is not removed efficiently, then there can be little or no net cooling produced for the CCD camera 32.

Accordingly, the thermal redistribution block 36 is designed so that maximum heat contact is made to the camera case 11. The camera case 11 is designed to dissipate as much heat as possible by using metals such as aluminum or copper. Both metallic and non-metallic thermal redistribution blocks 36 can be coated with a film of diamond which has the highest thermal conductivity of any material. Also, since the thermoelectric cooler 34 is an electrical device, it is also desirable to for the thermal redistribution block 36 to be an electrical insulator but have a high thermal conductivity. Usually these two properties are mutually exclusive. However, some materials do have these two combined properties. The requisite characteristics are to have a relatively simply crystal structure and are comprised of atoms that have low mass and are the same or vary only slightly in mass, and possess strong covalent (not metallic or ionic) chemical bonds between the atoms in the crystal. This gives rise to phonons, or lattice vibrations being able to efficiently conduct heat. The covalent bonds ensure that the material has an extremely high resistance to the conduction of electricity. The compounds that possess these desired properties are diamond, silicon carbide (SiC) and aluminum nitride (AlN). Thermal redistribution blocks 36 can be readily fabricated from ceramic powders of SiC and AlN. The powders are often made into a slurry, cast into the desired shape, and then fired in a furnace to sinter the particles into a dense solid.

The internal assembly also includes a controlling circuit board 38, which is electrically connected to the CCD camera chip 32 and the thermoelectric cooler 34 and is used to control both the CCD camera chip 32 and the thermoelectric cooler 34.

In order that the cooled CCD camera chip 32 is not heated by thermal contact with the controlling circuit board 38, a chip socket is extended with plastic extension pins. This also allows the thermoelectric coolers 34 to sit directly underneath the CCD camera chip 32, supported by the thermal redistribution block 36. The CCD camera chip 32 is also supported on each end, where there are no electrical leads, by non-thermally conducting, plastic supports that extend between the CCD camera chips 32 and the thermal redistribution block 36.

The plastic supports perform the triple purpose of providing a standoff, setting the distance between the bottom of the CCD chip 32 and the thermal redistribution block 36, thus setting a cavity height for the thermo-electric coolers 34. The plastic supports also provide a means to set the planarity of the CCD camera chip 32 in order that planarity is maintained with the Quarts optical window 24 and the “C”-mount adapter 28. This is critical in order to collect in-focus images. Furthermore, they provide thermal insulation between the cold CCD chip and the warm thermal redistribution block.

Alignment pins are often required to align the CCD chip 32 to the thermal redistribution block 36. However, a thermal path from the CCD chip 32 to the thermal redistribution block 36 must be avoided, as the cold generated by the top side of the thermoelectric coolers 34 must not go to waste. The alignment pins must be made of a thermally insulating material such as Delrin or a fiberglass-reinforced engineering plastic such as Ultem or PEEK.

It is then desirable to mount the thermal redistribution block 36 to at least three sides of the camera case 11 in order to conduct as much heat from the CCD camera 32 to the camera case 11, which is equipped with cooling fins 15 for increased surface area to transfer heat to the ambient air.

The next innovative feature is the use of a miniature pressure sensor inside of the evacuated CCD camera case 11. Until now, neither the manufacturer nor the end-user knew the level of vacuum inside of the camera case 11. After an initial evacuation, the pressure inside of the camera case 11 can slowly increase due to leaks or the out-gassing of materials contained within the camera case 11. This degrades performance due to transfer of heat by convection to the cooled CCD chip 32. In a preferred embodiment a microelectromechanical systems (MEMS) based sensor or miniature thermocouple or capacitance-based pressure gage is included in the interior of the camera case 11. The region of measurement of 1E-2 to 1E-4 Torr is of particular importance to the present invention.

In a preferred embodiment, the present invention includes indirect temperature control. The indirect temperature control comprises a temperature sensor, such as a thermocouple or RTD-based measurement device, for temperature control mounted on the thermal redistribution block 36. Measurement of temperature on the thermal redistribution block 36 is linearly proportional to the temperature of the CCD chip 32, which cannot be directly measured. Temperature control and stability is required for long duration exposures. This is also a measure of the cooling ability of the thermoelectric cooler 34, the heat-sinking characteristics of the thermal redistribution block 36 and the level of vacuum within the CCD camera case 11. Since, the heat sinking is constant and the level of vacuum is measured using the microelectromechanical systems (MEMS) based sensor or miniature thermocouple or capacitance-based pressure gage; as long as the vacuum or pressure range is known, then the precise relationship of the thermal redistribution block 36 temperature to the CCD camera chip 32 can be computed and controlled by controlling the thermoelectric cooler 34.

These methods and architectures described above can not only be utilized with CCD cameras, but with complementary metal oxide semiconductor (CMOS), and compound semiconductor imaging devices such as GaAs, InGaAs, InAlP, and the like. These methods and architectures can also be used in conjunction with image intensifiers that act as a pre-amplifier for the devices listed above.

Further, the present invention includes an improvement to the prior pressure evacuation methods. Previously a CCD camera case 11 used only a copper pinch tube 20 to seal a camera case containing a cooled CCD imaging device. The present invention also has a copper pinch tube 20 welded, brazed or soldered to a vacuum assembly 25. However, the present invention critically uses an indium lined copper pinch tube 20.

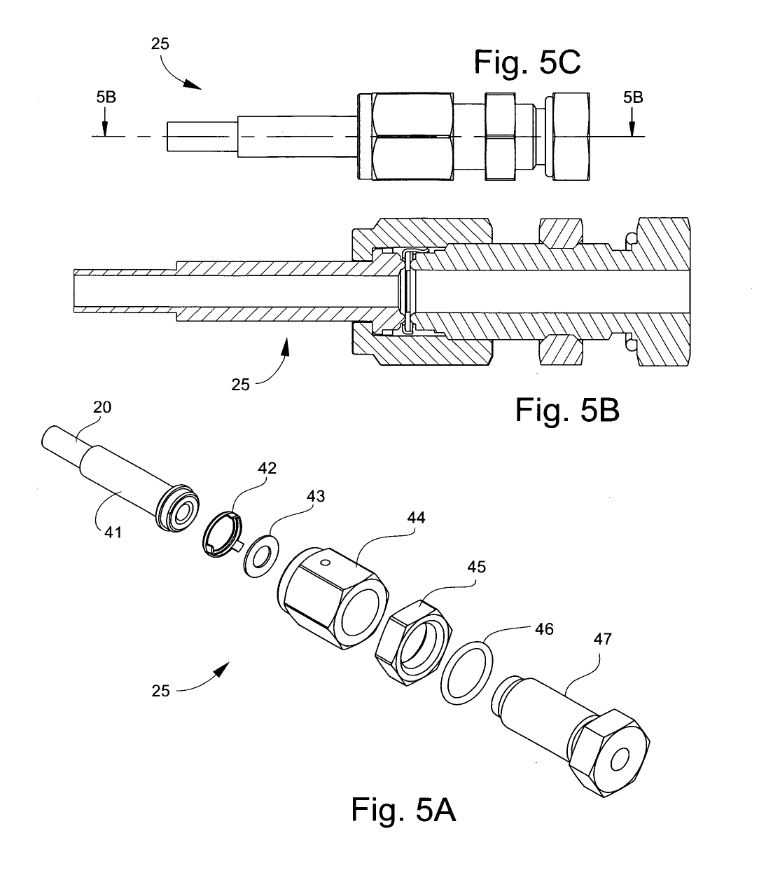

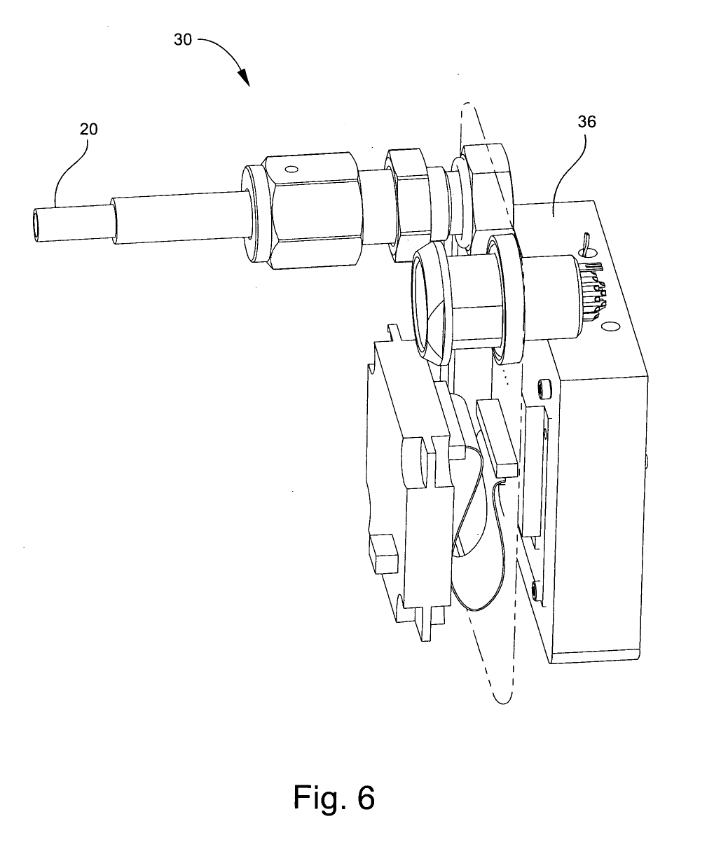

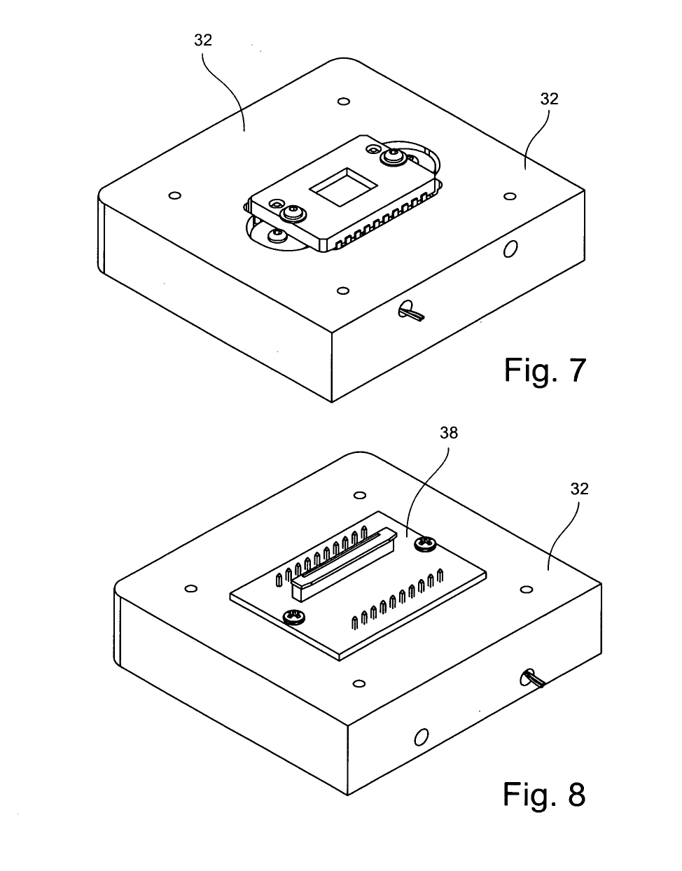

According to the present invention, and with special reference to FIGS. 5a-5c, the preferred vacuum assembly 25 comprises the indium lined copper pinch tube 20, a first stainless steel gland 41, a centering ring 42, a metal sealing disk or gasket 43, a compression nut 44, a compression nut for an O-ring 45, an O-ring 46, and a second stainless steel gland 47.

Once the camera case 11 is pumped with a vacuum pump to reduce the internal pressure, the copper pinch tube 20 is crimp sealed, also known as a cold welded, giving a vacuum tight seal. However, it is the unique and novel use of the vacuum assembly 25, converted to vacuum use by utilizing the O-ring 46 and compressive force in conjunction with the metal gasket seal 43 and indium lined copper pinch tube 20 welded to the first stainless steel gland 41, that makes this a novel, reliable and cost effective method to evacuate and seal a designed volume under vacuum.

In a preferred embodiment, the copper pinch tube 20 is lined with an indium foil insert 40. At least a portion of the insert 40 can be melted (melting point of indium is 135° C.) with localized heating, such as with a heat gun. This prevents the indium foil insert 40 from being moved from the sealing area of the copper crimp tube 20 while a vacuum is being drawn.

After the indium lined copper pinch tube 20 is crimped, the seal area is subject to localized heating to melt the contained indium to fill in any voids around the crimp area that may have been present. Finally, excess copper pinch tubing 20 is removed.

The copper pinch tube 20 methods employed in the previous sections are extremely robust and have a very low rate of vacuum leakage. However, this method suffers from the drawback of creating a relative long apparatus. As cameras shrink in size, this can be a dimensional limitation. In an alternate embodiment, a vacuum adapter is placed over the vacuum port of the camera and then sealed using a disc with adhesive dispensed over the sealing surface of the vacuum port to seal the camera under vacuum. One first begins with a sealing disc with a press-fit PEM stud in the center of the disc. Next the disc is attached to a spring-loaded rod inside of the vacuum adapter. Then a vacuum compatible epoxy is dispensed around the vacuum port of the camera. The vacuum adapter is then mounted to the camera housing with an o-ring and clamped into place with machine screws. The assembly is then pumped down to base pressure. Then the spring is released, causing the disc to move forward to the sealing surface and to remain under pressure. The vacuum is then released from the vacuum pumping adapter. This causes an additional one atmosphere of pressure to push down on the disc. After allowing time for the epoxy to cure, the rod is unscrewed from the disc and the vacuum adapter is removed from the camera. Additional epoxy can then be added at to ensure a vacuum-tight seal.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A method for improving the dynamic range of a charge-coupled device camera comprising the steps of:
a. providing a charge-coupled device camera;
b. enclosing the charge-coupled device camera in vacuum sealable camera case;
c. evacuating the camera case using a pinch tube assembly, wherein the pinch tube assembly includes an indium foil inserted into a copper pinch tube prior to sealing the pinch tube;
d. sealing the pinch tube assembly in the vicinity of the indium foil;
e. cooling the charge-coupled device camera using a thermoelectric cooler, wherein the cooler shunts excess heat through a thermal redistribution block into the camera case; and
f. monitoring both the pressure inside of the camera case and the temperature of the charge-coupled device camera in order to stably control the temperature of the charge-coupled device.

2. The method according to claim 1 further including the step of melting the indium foil subsequent to pinching off the copper pinch tube in order to fill in any voids or defects in the pinch process.

3. The method according to claim 1 further including the step of electrically controlling the thermoelectric cooling in response to a detected pressure or temperature measurement received from inside the camera case.

4. A charge-coupled device camera architecture that improves the dynamic range of the charge-coupled device camera comprising;
a. a charge-coupled device camera contained within a vacuum capable camera case and electrically attached to the outside of the camera case;
b. a thermoelectric cooler thermally attached to a back side of the charge-coupled device camera and electrically attached to the outside of the camera case;
c. a thermal redistribution block thermally attached to the thermoelectric cooler and further thermally attached to the camera case;
d. a pressure measuring mechanism attached to an inside surface of the camera case and electrically connected to the outside of the camera case;
e. a temperature measuring mechanism attached to a surface of the thermal redistribution block and electrically connected to the outside of the camera case; and
f. a vacuum evacuation assembly that comprises a copper pinch tube, said copper pinch tube including a thin layer of indium inside of the copper pinch tube in the area expected to pinched when vacuum sealing the camera case.

5. The charge-coupled device camera architecture according to claim 4 further comprising head dissipation fins located on the outside of the camera case;

6. The charge-coupled device camera architecture according to claim 5 further comprising [symbol]
